(19) United States
(12) Patent Application Publication
(10) Pub. No.: US 2011/0259529 A1
(43) Pub. Date: Oct. 27, 2011

(54) Window System Useful for Blocking Direct Sunlight

(75) Inventor: Robert D. Clear, Berkeley, CA (US)

(73) Assignee: THE REGENTS OF THE UNIVERSITY OF CALIFORNIA, Oakland, CA (US)

(21) Appl. No.: 13/092,857

(22) Filed: Apr. 22, 2011

Related U.S. Application Data
(60) Provisional application No. 61/326,910, filed on Apr. 22, 2010.

(51) Int. Cl. E05F 15/20; A47H 23/00; E06B 9/38

(52) U.S. Cl. 160/7; 160/115; 160/123

(57) ABSTRACT

The present invention provides for a device for blocking direct light from a light source, wherein the device comprises two arrays of elongated slats and a means to coordinately move the two arrays relative to each other within a range of configuration, wherein in at least one configuration the two arrays block direct light from a light source to more than one location incident to the light source while not blocking other views through the two arrays from the more than one location.

### CROSS-REFERENCE TO RELATED APPLICATIONS

This application claims the benefit of U.S. Provisional Application No. 61/326,910, filed Apr. 22, 2010, which is incorporated herein by reference in its entirety.

### STATEMENT OF GOVERNMENTAL SUPPORT

The invention was made with government support under Contract No. DE-AC02-05CH11231 awarded by the U.S. Department of Energy. The government has certain rights in the invention.

### FIELD OF THE INVENTION

The present invention is in the field of window systems for blocking sunlight.

### BACKGROUND OF THE INVENTION

Currently window blinds have the disadvantage that when deployed to block direct sunlight from passing through the window the blinds also substantially block views to the outside which do not have direct sunlight passing through the window. When the sun is perpendicular to the window the blinds have to be completely closed from eye-height and above to block the sun, and therefore block all view above eye height. Window pleats when deployed to block direct sunlight from passing through the window also substantially block views to the outside which do not have direct sunlight passing through the window.

### SUMMARY OF THE INVENTION

The present invention provides for a device for blocking direct light from a light source, wherein the device comprises two arrays of elongated slats and a means to coordinately move the two arrays relative to each other within a range of configuration, wherein in at least one configuration the two arrays block direct light from a light source to more than one location incident to the light source while not blocking other views through the two arrays from the more than one location. In one embodiment of the invention, for each angle for which the light sun, such as the sun, is incident to the device, there is at least one configuration of the two arrays whereby the light from the light source is blocked on the other side of the array.

In some embodiments of the present invention, the device is for blocking direct light from the sun, comprising essentially a picket fence with adjustable pickets. In one embodiment it comprises two parallel transparent sheets, with a regular array of opaque stripes covering 50% of each surface. The sheets are slid past each other by up to one slat width to block different angles. A regular shade or Venetian blind is effectively a two-dimensional device that blocks an area of the window. Because the sheets are displaced perpendicularly from the line of sight relative to each other it is a three-dimensional object, and the opaque areas will block angles, not areas. The sun is so distant from any practical window, that it will appear at the same angle to observers within a room. The device is therefore capable of blocking the view of the sun for all observers within a room, while still permitting a view to other outside angles, regardless of the location of the sun in the sky.

In some embodiments of the present invention, the device is for blocking direct light from the sun, comprising (a) two sheets, wherein each sheet comprises a checkerboard pattern of alternate opaque, essentially opaque, or substantially opaque squares which block the transmission of all, essentially all, or substantially all of the light rays, and transparent or essentially transparent squares, (b) a means to coordinately move the two sheets relative to each other within a range of configuration, wherein in at least one configuration the two sheets block direct light from the sun to more than one location incident to the sun while not blocking other views through the two sheets from the more than one location. The device can cover an aperture, such as an aperture of a room, chamber, or the like. The aperture can be a window, transparent door, or the like.

In some embodiments of the present invention, the device is for blocking direct light from the sun, wherein the device comprises two arrays of elongated slats and a means to coordinately move the two arrays relative to each other within a range of configuration, wherein in at least one configuration the two arrays block direct light from the sun to more than one location incident to the sun while not blocking other views through the two arrays from the more than one location. The device can cover an aperture, such as an aperture of a room, chamber, or the like. The aperture can be a window, transparent door, or the like.

In some embodiments of the present invention, the device comprises two arrays of elongated slats comprising each elongated slat of a first array is attached to a corresponding elongated slat of a second array by a means of attachment, wherein (a) the elongated slats of the first array are parallel to the elongated slat of the second array in all configurations, (b) each means of attachment is flexibly attached to one end of the elongated slat of the first array and the opposing end of the corresponding end, and (c) the means of attachment is capable of rotating about its longitudinal axis, by the means to coordinately move the two arrays, while the elongated slats of the first and second arrays remain parallel to each other.

In some embodiments of the present invention, the device comprises two arrays of elongated slats comprising each elongated slat of a first array is attached to a corresponding elongated slat of a second array by a means of attachment, wherein (a) the elongated slats of the first array are parallel to each other in all configurations, (b) the elongated slats of the second array are parallel to each other in all configurations, (c) the elongated slats of the first array are parallel to the elongated slat of the second array in only one configuration, (d) each means of attachment is rigidly attached to one end of the elongated slat of the first array and the opposing end of the corresponding end, and (d) the means of attachment is capable of rotating about its longitudinal axis, by the means to coordinately move the two arrays, such that the configuration of the elongated slats of the first and second arrays are changed.

In some embodiments of the present invention, the device comprises two arrays of elongated slats wherein elongated slats of the first and second arrays have fixed widths of essentially equal dimension, elongated slats of the first and second arrays are disposed to each other such that the elongated arrays of the two arrays are parallel to each other and are up to one slat width from each other, and the means to coordinately move the two arrays is capable of changing the configuration of the two arrays.

Depending on the disposition of the two arrays of elongated slats relative to each other, at least one configuration the two arrays block direct light from the sun to more than one location incident to the sun while not blocking other views through the two arrays from the more than one location.

The present invention also provides for a method of blocking direct light from a light source to a location, comprising: (a) providing a device of the present invention between the light source and a location, and (b) adjusting the configuration of the elongated slats by use of the means to coordinately move the two arrays relative to each other, such that the device blocks direct light from a light source to the location.

In some embodiments, the elongated slats are in a horizontal position. In other embodiments, the elongated slats are in a vertical position.

In some embodiments, the device can block direct light from the light source at angles up to about 80°. In some embodiments, the device can block direct light from the light source at angles about 60°.

In some embodiments, when the squares or slats are about 0.25 inches wide, the space between the opaque squares or elongated slats are about 0.05 to about 1.25 inches, with 0.2 inch of rise. Routine experimentation by one skilled in the art can determine the optimum dimensions of the device.

In some embodiments, the means of adjusting is performed manually or automatically by an electrical device. Optionally, the means of adjusting can be adjusted through the detection of light by a light sensor, such as a photocell. In some embodiments, one photocell is placed just above an opaque square or slat further away from the light source (such as elongated slat 20), and another below photocell is placed just below the opaque square or slat further away from the light source (such as elongated slat 20). When the bottom sensor senses more light than the top sensor, the sheet or array of elongated slats further away from the light source is moved forward and/or down. When the top sensor senses more light than the bottom sensor, the sheet or array of elongated slats further away from the light source is moved backward and/or up. Optionally, the means of adjusting can be adjusted automatically through a timer by corresponding the time of the day with the known or predicted position of the sun in the sky. Such electrical devices and sensors are well known to those skilled in the art.

The present invention has the advantage against a regular venetian blind of always permitting some view angles. In automatic operation, it would completely block the sun, no matter where in the sky it was, while still admitting light.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 shows one embodiment of the device of the present invention. Panels A and B show two different configuration of the two arrays.

FIG. 2 shows one embodiment of the device of the present invention. Panels A and B show two different configuration of the two arrays.

FIG. 3 shows one embodiment of the device of the present invention. Panels A and B show two different configuration of the two arrays.

FIG. 4 shows one embodiment of the device of the present invention. Panels A and B show two different configuration of the two arrays.

FIG. 5 shows one embodiment of the device of the present invention.

FIG. 6 shows a three-dimensional view of the one embodiment of the device.

### DETAILED DESCRIPTION OF THE INVENTION

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

As used in the specification and the appended claims, the singular forms “a”, “an”, and “the” include plural references unless the context clearly dictates otherwise. Thus, for example, reference to a “slat” includes a single slat as well as a plurality of slats.

The terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

These and other objects, advantages, and features of the invention will become apparent to those persons skilled in the art upon reading the details of the invention as more fully described below.

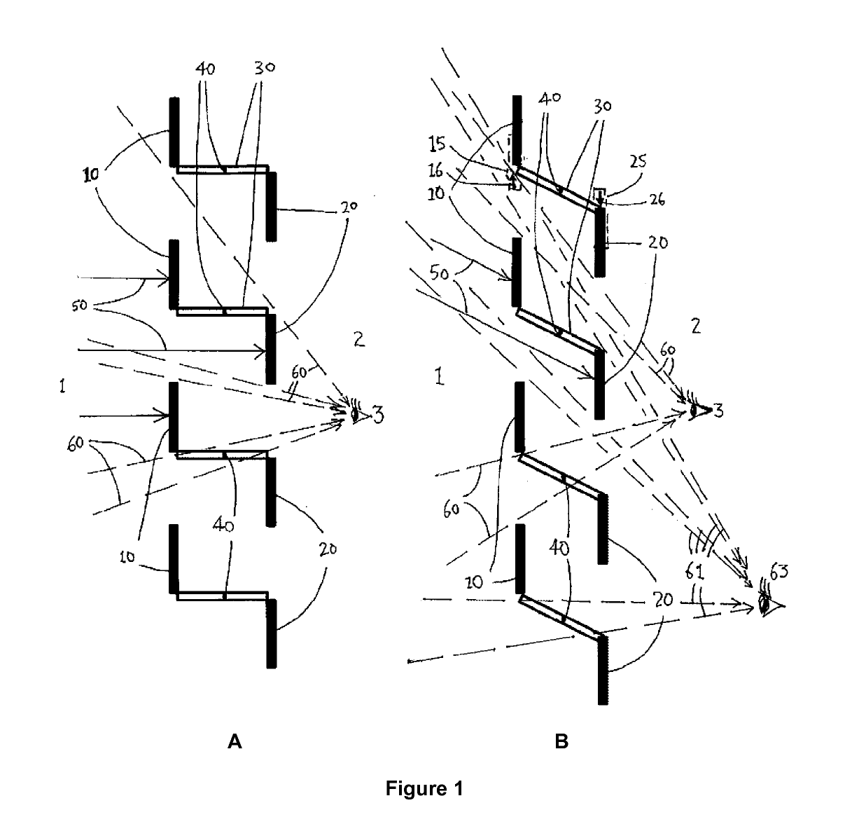

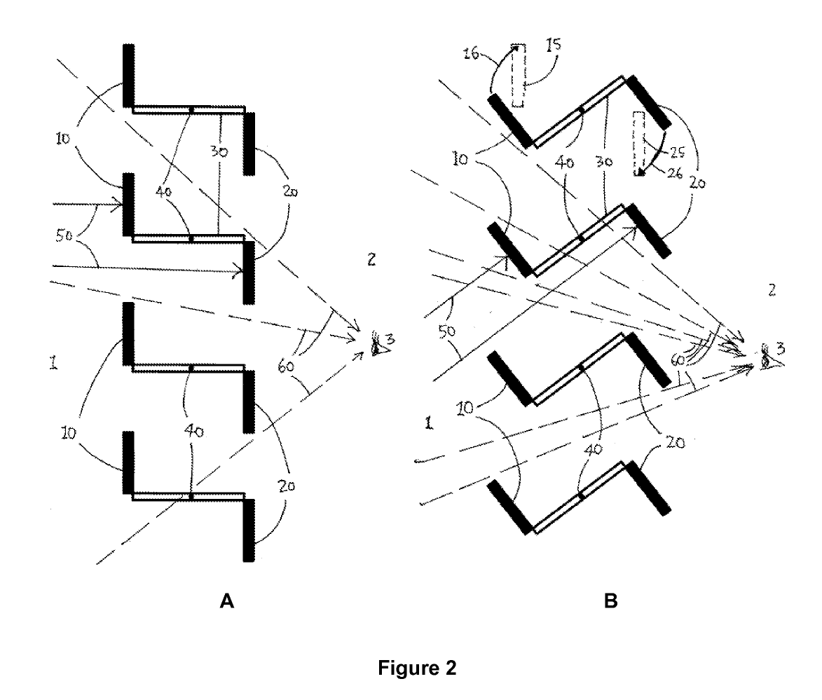

FIG. 1 shows the cross-section of one embodiment of the device of the present invention. Panels A and B show two different configurations of the two arrays. FIG. 1 shows the cross-section of the elongated slats 10 of the first array and the elongated slats 20 of the second array which separate space 1 and space 2 wherein the observer or point of view 3. The elongated slats 10 and 20 are opaque, essentially opaque, or substantially opaque and block the transmission of all, essentially all, or substantially all of the light rays 50. The light rays 50 are light rays transmitted from the light source which travel in the direction indicated by light rays 50. Elongated slats 10 and 20 are attached by a means of attachment 30 which is transparent, essentially transparent, or more transparent than the elongated slats 10 or 20. Axis 40 indicates the axis by which the means of attachment 30 is rotated in order to dispose the elongated slats 10 and 20 in a different or desired configuration. Elongated slats 10 and 20 are flexibly attached to the means of attachment 30. Panel A shows the configuration of the device deployed to maximally block the light rays 50 when the light rays travel in a direction perpendicular to the elongated slats 10 and 20. Panel B shows the configuration of the device deployed to maximally block the light rays 50 when the light rays travel in a direction about 30° incident to the elongated slats 10 and 20. Light rays 60 and 61 are not light rays transmitted directly from the light source. Light rays 60 and 61 may be light rays which originated from the light source. Light rays 60 represent views that can be seen or observed by observer 3, or view angles available to the observer, such as the sky, vegetation, or built environment when the observer is in a room looking outside a window. FIG. 1 also shows a second observer or point of view 63 at a different location than 3. Light rays 61 represent views that can be seen or observed by the observer or point of view 63. As it can clearly be seen, the angles available for viewing to observer 3 and 63 are different. Although the ability of the device to block the source of light, such as the sun, is unaffected by location, the angles available for viewing changes with a periodicity which has a width of the slats. At close distances (such as about 3-4 inches from the device, when the slats have a width of about one inch) the view differences are significant to observers or points of view 3 and 63. At normal viewing distances of 3 or 4, or more, feet from the device, the differences are on the order of two degrees or less. (This is also true for observers occupying positions different from observer 3 in FIGS. 2-4. The previous disposition of the elongated slate 10 is indicted by 15, and the previous disposition of the elongated slate 20 is indicted by 25. The direction of movement of the elongated slate 10 from the configuration in Panel A to the configuration in Panel B is indicated by arrow 16. The direction of movement of the elongated slate 20 from the configuration in Panel A to the configuration in Panel B is indicated by arrow 26. When the device is a window barrier, the light source is the sun, space 1 is the outside, and space 1 is the inside of a room or chamber.

In some embodiments of the invention, when the cross-section width of the slats are about one inch, then the observer or point of view 3 at least about one to two inches from the device. When the observer or point of view is this close to the device, the slats appear large enough to provide substantial shading at some locations and not others. In an extreme case if the observer or point of view is microns from the inner side or plane of the device. If the observer or point of view faces an inner slat, there is no view at all. If you are in a gap, you have views permitted by the spacing of the device. In normal viewing, you are sufficiently far from the device that differences in view between one location and the next are minor (about 2° at 30 inches with an about one inch wide slat).

FIG. 2 shows the cross-section of another embodiment of the device of the present invention. Panels A and B show two different configurations of the two arrays. FIG. 2 shows the cross-section of the elongated slats 10 of the first array and the elongated slats 20 of the second array which separate space 1 and space 2 wherein the observer or point of view 3. The elongated slats 10 and 20 are opaque, essentially opaque, or substantially opaque and block the transmission of all, essentially all, or substantially all of the light rays 50. The light rays 50 are light rays transmitted from the light source which travel in the direction indicated by light rays 50. Elongated slats 10 and 20 are attached by a means of attachment 30 which is transparent, essentially transparent, or more transparent than the elongated slats 10 or 20. Axis 40 indicates the axis by which the means of attachment 30 is rotated in order to dispose the elongated slats 10 and 20 in a different or desired configuration. Elongated slats 10 and 20 are rigidly attached to the means of attachment 30. Panel A shows the configuration of the device deployed to maximally block the light rays 50 when the light rays travel in a direction perpendicular to the elongated slats 10 and 20. Panel A shows the configuration where oblique sun angles are blocked, and the direct view (rays 50 and 55) is maximally open. (This is also true for the devices shown in the other figures.) Panel B shows the configuration of the device deployed to maximally block the light rays 50 when the light rays travel in a direction about 30° incident to the elongated slats 10 and 20. Light rays 60 are not light rays transmitted directly from the light source. Light rays 60 may be light rays which originated from the light source. Light rays 60 represent views that can be seen or observed by the observer 3. The previous disposition of the elongated slate 10 is indicted by 15, and the previous disposition of the elongated slate 20 is indicted by 25. The direction of movement of the elongated slate 10 from the configuration in Panel A to the configuration in Panel B is indicated by arrow 16. The direction of movement of the elongated slate 20 from the configuration in Panel A to the configuration in Panel B is indicated by arrow 26. When the device is a window barrier, the light source is the sun, space 1 is the outside, and space 1 is the inside of a room or chamber.

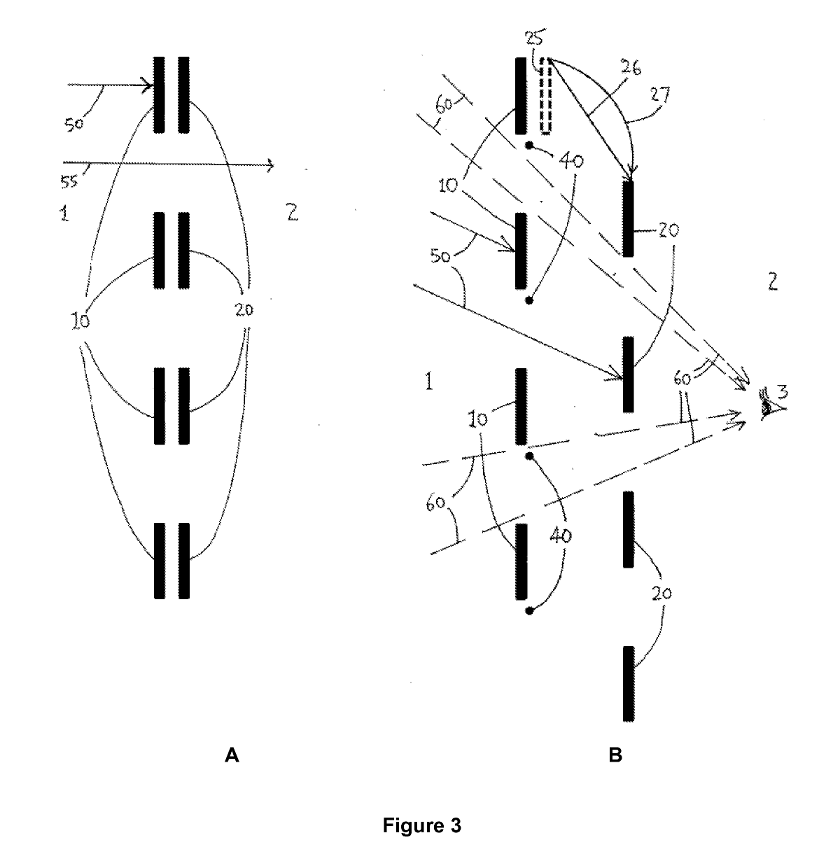

FIG. 3 shows the cross-section of another embodiment of the device of the present invention. Panels A and B show two different configurations of the two arrays. FIG. 2 shows the cross-section of the elongated slats 10 of the first array and the elongated slats 20 of the second array which separate space 1 and space 2 wherein the observer or point of view 3. The elongated slats 10 and 20 are opaque, essentially opaque, or substantially opaque and block the transmission of all, essentially all, or substantially all of the light rays 50. The light rays 50 are light rays transmitted from the light source which travel in the direction indicated by light rays 50. Axis 40 indicates the axis of rotation by which elongated slat 20 is moved in direction 27 in order to dispose the elongated slats 10 and 20 in a different or desired configuration. Alternately, elongated slat 20 can be moved in a straight movement in direction 26 in order to dispose the elongated slats 10 and 20 in a different or desired configuration. Panel A shows the configuration of the device deployed wherein the light rays 50 and 55 are not maximally blocked. Light ray 50 is blocked by the elongated slat 10, while light ray 55 passes through into space 2. Panel B shows the configuration of the device deployed to maximally block the light rays 50 when the light rays travel in a direction about 30° incident to the elongated slats 10 and 20. Light rays 60 are not light rays transmitted directly from the light source. Light rays 60 may be light rays which originated from the light source. Light rays 60 represent views that can be seen or observed by the observer 3. The previous disposition of the elongated slate 20 is indicted by 25. The direction of movement of the elongated slate 20 from the configuration in Panel A to the configuration in Panel B is indicated by arrow 26 or 27. Elongated slats 10 do not move. When the device is a window barrier, the light source is the sun, space 1 is the outside, and space 1 is the inside of a room or chamber.

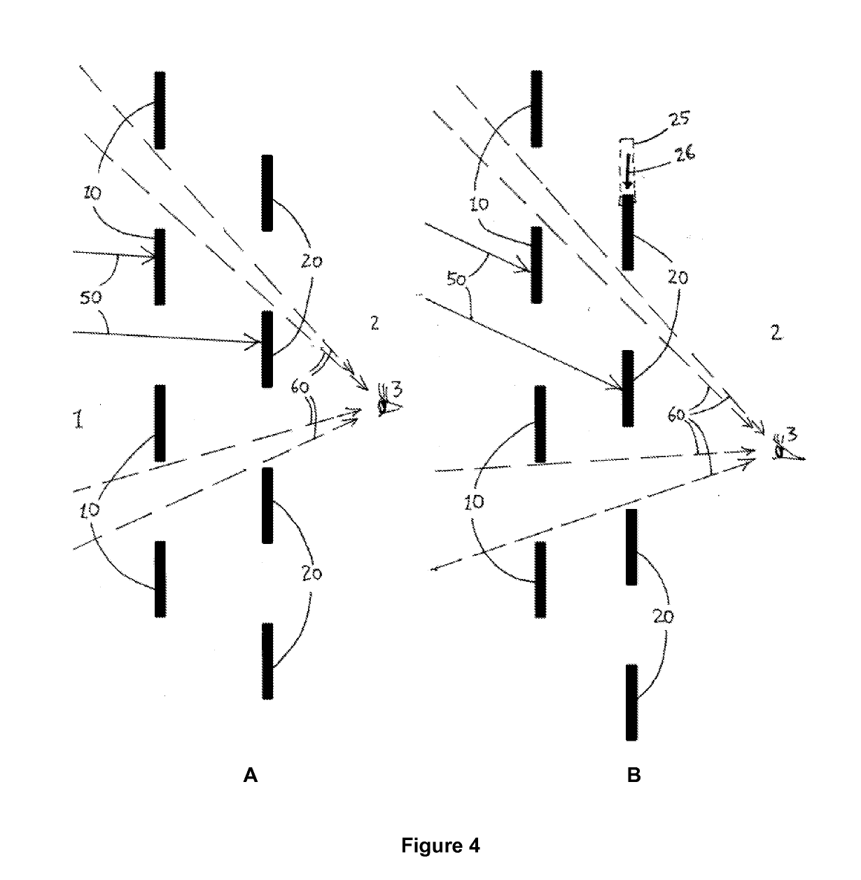

FIG. 4 shows the cross-section of another embodiment of the device of the present invention. Panels A and B show two different configurations of the two arrays. FIG. 4 shows the cross-section of the elongated slats 10 of the first array and the elongated slats 20 of the second array which separate space 1 and space 2 wherein the observer or point of view 3. The elongated slats 10 and 20 are opaque, essentially opaque, or substantially opaque and block the transmission of all, essentially all, or substantially all of the light rays 50. The light rays 50 are light rays transmitted from the light source which travel in the direction indicated by light rays 50. Panel A shows the configuration of the device deployed to maximally block the light rays 50 when the light rays travel in a direction perpendicular to the elongated slats 10 and 20. Panel B shows the configuration of the device deployed to maximally block the light rays 50 when the light rays travel in a direction about 30° incident to the elongated slats 10 and 20. Light rays 60 are not light rays transmitted directly from the light source. Light rays 60 may be light rays which originated from the light source. Light rays 60 represent views that can be seen or observed by the observer 3. The previous disposition of the elongated slate 20 is indicted by 25. The direction of movement of the elongated slate 20 from the configuration in Panel A to the configuration in Panel B is indicated by arrow 26. When the device is a window barrier, the light source is the sun, space 1 is the outside, and space 1 is the inside of a room or chamber.

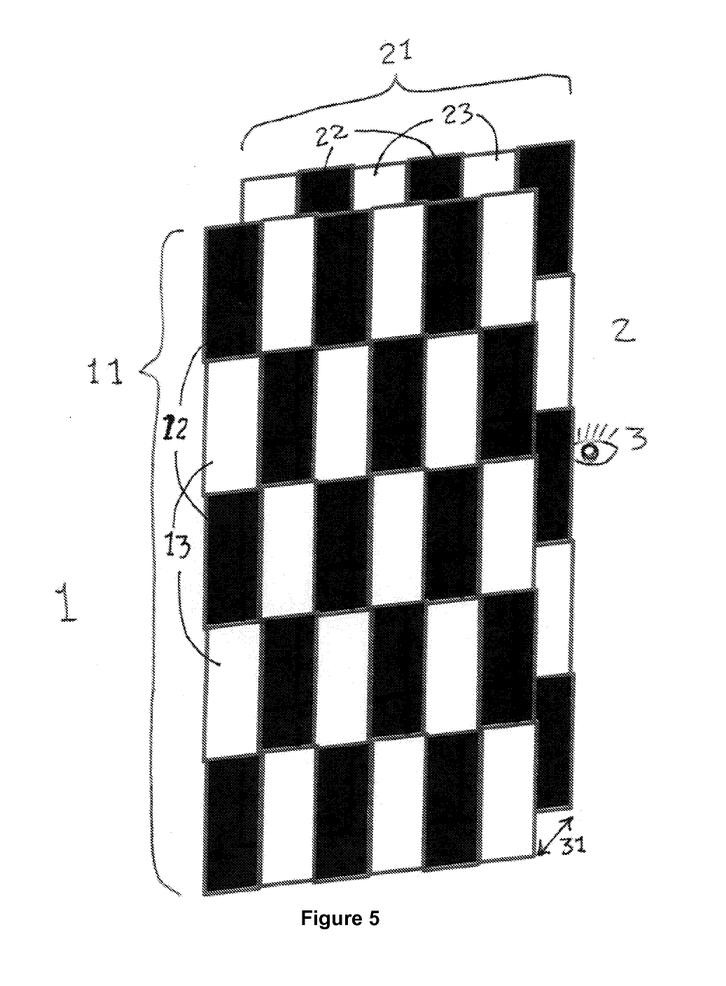

FIG. 5 shows a three-dimensional view of another embodiment of the device of the present invention. First sheet 11 comprises a checkerboard of opaque squares 12 and transparent squares 13. Second sheet 21 comprises a checkerboard of opaque squares 22 and transparent squares 23, wherein the opqaque and transparent are inverse to the arrangement on first sheet 11. Distance 31 is the linear distance between first sheet 11 and second sheet 21. Space 1 is outside the sheet, while space 2 is inside the sheet and where observe or point of view 3 is located. The light source is located in space 1.

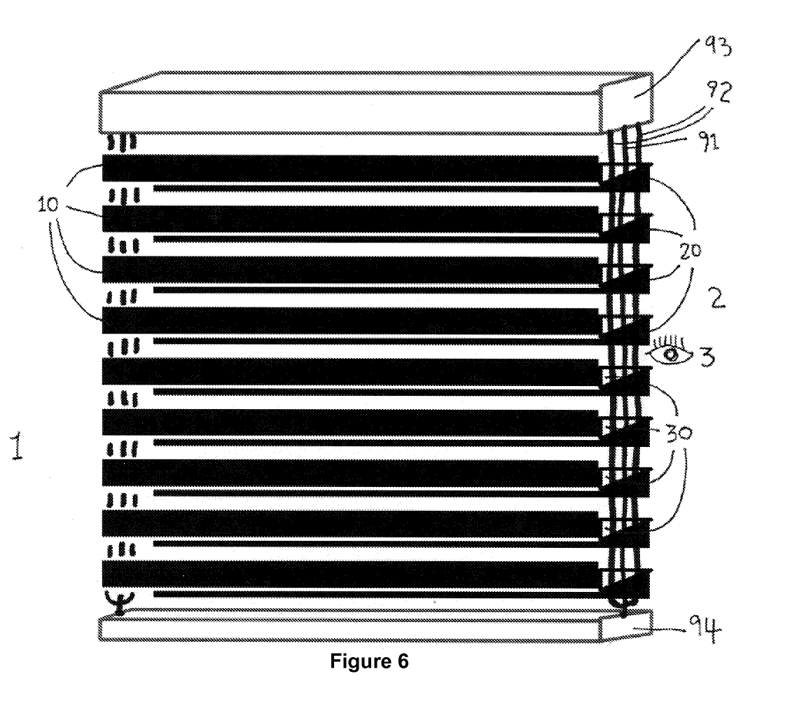

FIG. 6 shows a three-dimensional view of the device depicted in FIG. 2. The device of FIG. 6 has slates in the horizontal position. Elongated slats 10 and elongated slats 20 are opaque and are attached to each other by the means of attachment 30 which is transparent. Housing 90 contains the mechanism for adjusting cord 91 which adjusts how far down the elongated slats are lowered, and cord 92 adjusts the orientation or rotation of the slats 10 and 20 and the means of attachment 30. Typically, housing 90 is attached to the top of a window. Bar 94 is a weight which helps keep the cord 91 tight. Space 1 is outside the sheet, while space 2 is inside the sheet and where observe or point of view 3 is located. The light source is located in space 1. Spaces 1 and 2 correspond to the spaces 1 and 2 in FIG. 2.

It is to be understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

All patents, patent applications, and publications mentioned herein are hereby incorporated by reference in their entireties.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A device comprising two arrays of elongated slats wherein elongated slats of the first and second arrays have fixed widths of essentially equal dimension, elongated slats of the first and second arrays are disposed to each other such that the elongated arrays of the two arrays are parallel to each other and are up to one slat width from each other, and the means to coordinately move the two arrays is capable of changing the configuration of the two arrays, wherein in at least one configuration the two arrays block direct light from a light source to more than one location incident to the light source while not blocking other views through the two arrays from the more than one location.

2. The device of claim 1, wherein the device is located to cover a window which opens the outside, wherein the light source is the sun.

3. The device of claim 1, wherein the means to coordinately move the two arrays is performed manually or automatically by an electrical device.

4. The device of claim 3, wherein the means to coordinately move the two arrays is performed automatically by an electrical device which in turn is controlled through the detection of light by a light sensor.

5. The device of claim 4, wherein the light sensor is a photocell.

6. The device of claim 5, wherein the second array is further away from the light source than the first array, wherein a top photocell is located just above a slat of the second array, and a bottom photocell is located just below the slat, such that when the bottom photocell senses more light than the top photocell, the second array is moved forward and/or down, and when the top photocell senses more light than the bottom photocell, the second array is moved backward and/or up.

7. The device of claim 4, wherein, the means to coordinately move the two arrays moves the two arrays automatically through a timer by corresponding the time of the day with the known or predicted position of the sun in the sky.

8. The device of claim 1, wherein (a) the elongated slats of the first array are parallel to the elongated slat of the second array in all configurations, (b) each means of attachment is flexibly attached to one end of the elongated slat of the first array and the opposing end of the corresponding end, and (c) the means of attachment is capable of rotating about its longitudinal axis, by the means to coordinately move the two arrays, while the elongated slats of the first and second arrays remain parallel to each other.

9. The device of claim 1, wherein (a) the elongated slats of the first array are parallel to each other in all configurations, (b) the elongated slats of the second array are parallel to each other in all configurations, (c) the elongated slats of the first array are parallel to the elongated slat of the second array in only one configuration, (d) each means of attachment is rigidly attached to one end of the elongated slat of the first array and the opposing end of the corresponding end, and (d) the means of attachment is capable of rotating about its longitudinal axis, by the means to coordinately move the two arrays, such that the configuration of the elongated slats of the first and second arrays are changed.

10. A device for blocking direct light from the sun, comprising: (a) two sheets, wherein each sheet comprises a checkerboard pattern of alternate opaque, essentially opaque, or substantially opaque squares which block the transmission of all, essentially all, or substantially all of the light rays, and transparent or essentially transparent squares, (b) a means to coordinately move the two sheets relative to each other within a range of configuration, wherein in at least one configuration the two sheets block direct light from the sun to more than one location incident to the sun while not blocking other views through the two sheets from the more than one location.

11. A device for blocking direct light from the sun, wherein the device comprises two arrays of elongated slats and a means to coordinately move the two arrays relative to each other within a range of configuration, wherein in at least one configuration the two arrays block direct light from the sun to more than one location incident to the sun while not blocking other views through the two arrays from the more than one location.
